(19) United States
(12) Patent Application Publication
(10) Pub. No.: US 2008/0238884 A1
(43) Pub. Date: Oct. 2, 2008

(54) EDGE SENSORS FORMING A TOUCHSCREEN

(76) Inventor: DIVYASIMHA HARISH, Fremont, CA (US)

Correspondence Address: Raj Abhyanker LLP;c/o Iatellevate, P.O. Box 52050, Minneapolis, MN, 55402, US

(21) Appl. No.: 12/058,857

(22) Filed: Mar. 31, 2008

Related U.S. Application Data
(60) Provisional application No. 60/920,966, filed on Mar. 29, 2007.

(51) Int. Cl. G06F 3/045; G06F 3/041

(52) U.S. Cl. 345/174; 345/173

(57) ABSTRACT

The methods, systems, and apparatuses of edge sensors forming a touchscreen are disclosed. In one embodiment, a touchscreen (e.g., may be in rectangular shape) includes a display area of the touchscreen, a set of edge sensors (e.g., may be piezo-resistive, microelectromechanical sensors, and/or capacitive sensors) at boundary locations of the display area of the touchscreen, and a set of electronics (e.g., may filter and to compensates measurements of the set of edge sensors to create more accurate readings using an error correction module) to determine a location of a force and a magnitude of the force applied on the display area of the touchscreen using an algorithm that considers measurements the set of edge sensors.

### PRIORITY CLAIM OR CLAIMS OF PRIORITY

This disclosure claims priority from a U.S. provisional patent application No. 60/920,966, filed on Mar. 29, 2007.

### FIELD OF TECHNOLOGY

This disclosure relates generally to technical fields of measuring devices and, in one embodiment, to edge sensors forming a touchscreen.

### BACKGROUND

A touchscreen may be a display which can detect a location of a force (e.g., a touch) in a display area of the touchscreen. The display area may be able to detect the location of the force because an entire area of the display area may be created as a capacitive grid. When the force is detected on a surface of the touchscreen, a change in a capacitance reading in an area of the capacitive grid portion affected by the force may be detected.

The capacitive grid may be expensive to manufacture because every location on the display may need to be covered by the capacitive grid. Furthermore, detecting the force may require interrogation of each location of the capacitive grid. This may be a slow and processor intensive process because it may take time to examine each location of the capacitive grid for the change in the capacitance.

### SUMMARY

The methods, systems, and apparatuses of edge sensors forming a touchscreen are disclosed. In one aspect, a touchscreen includes a display area of the touchscreen, a set of edge sensors at boundary locations of the display area of the touchscreen, and a set of electronics to determine a location of a force and a magnitude of the force applied on the display area of the touchscreen using an algorithm that considers measurements the set of edge sensors.

The algorithm may be a center of force algorithm that may multiply individual force reading of each of the set of edge sensors with a position on a plane of each of the set of edge sensors to calculate a number, and divides the number by a sum of the individual force readings of all of the edge sensors. The display area may be a rectangular shape, and there may be one edge sensor at each corner of the rectangular shape. The set of edge sensors may be piezo-resistive sensors. The set of edge sensors may be microelectromechanical sensors. The set of edge sensors may be capacitive sensors. The capacitive sensors may include a tilt correction layer to minimize an effect on a tilt on an upper surface of the capacitive sensor.

The set of electronics may filter and/or compensate measurements of the set of edge sensors to create more accurate readings using an error correction module. The touchscreen may be removable from the display area (e.g., such that the touchscreen may be placed on different display areas). The touchscreen may include a set of vibrating elements to provide a sensory feedback when the force may be applied on the display area. The location of the force and/or the magnitude of the force may be measurable even when applied in an area slightly outside the display area.

In another embodiment, a method includes capturing an observed measurement of a force from each of a set of edge sensors near the force, and determining the location of the force and magnitude of the force applied on a display area based on an algorithm that considers a reading of the force from each of the set of edge sensors near the force.

The method may multiply individual force reading of each of the set of edge sensors with a position on a plane of each of the set of edge sensors to calculate a number. The method may divide the number by a sum of the individual force readings of all of the edge sensors to determine the location of the force. The display area may be a rectangular shape, and there may be one edge sensor at each corner of the rectangular shape. The set of edge sensors may be piezo-resistive sensors. The set of edge sensors may be microelectromechanical sensors. The set of edge sensors may be capacitive sensors.

A system includes a touchscreen surface, a base support surface, a set of edge sensors between the touchscreen surface and the base support surface at corners of the surface to detect a force placed on the touchscreen, and a set of electronics associated with the set of edge sensors to determine a location of a force and a magnitude of the force applied on the touchscreen surface using an algorithm that considers measurements from the set of edge sensors.

The algorithm may be a center of force algorithm that may multiply individual force reading of each of the set of edge sensors with a position on a plane of each of the set of edge sensors to calculate a number, and divides the number by a sum of the individual force readings of all of the edge sensors.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system diagram of a touch screen interface associated with a measurement generator module and/or a data processing system, according to one embodiment.

FIG. 2 is a three-dimensional view of edge sensor devices placed between a touch screen and a base support, according to one embodiment.

FIG. 3A is a three-dimensional view of an edge sensor device having sensor capacitor and/or a reference capacitor, according to one embodiment.

FIGS. 4A, 4B, 4C, and 4D are cross-sectional views of the capacitive force measuring device, whereas FIGS. 4A, 4B, and 4C display three different ways of forming the sensor capacitor and FIG. 4D displays a formation of the reference capacitor, according to one embodiment.

FIG. 5 is a process view of generating a measurement based on a force applied to an edge sensor device 300 of FIG. 3 and/or communicating the measurement using a set of electronics, according to one embodiment.

FIG. 6 is a three-dimensional view of a personal digital assistant (PDA) 600 having a touch screen based on edge sensor devices, according to one embodiment.

FIG. 7 is a three-dimensional view of a touch screen monitor 700, according to one embodiment.

FIG. 8 is an illustrative view of a touch screen wall, according to one embodiment.

FIG. 9 is a system view of information processing from various input/output devices, according to one embodiment.

FIG. 10 is a diagrammatic system view of a data processing system in which any of the embodiments disclosed herein may be performed, according to one embodiment.

FIG. 11 is a process flow of capturing a measurement of force from a set of edge sensors, according to one embodiment.

Other features of the present embodiments will be apparent from the accompanying drawings and from the detailed description that follows.

### DETAILED DESCRIPTION

The methods, systems, and apparatuses of edge sensors forming a touchscreen are disclosed. Although the present embodiments have been described with reference to specific example embodiments, it will be evident that various modifications and changes may be made to these embodiments without departing from the broader spirit and scope of the various embodiments.

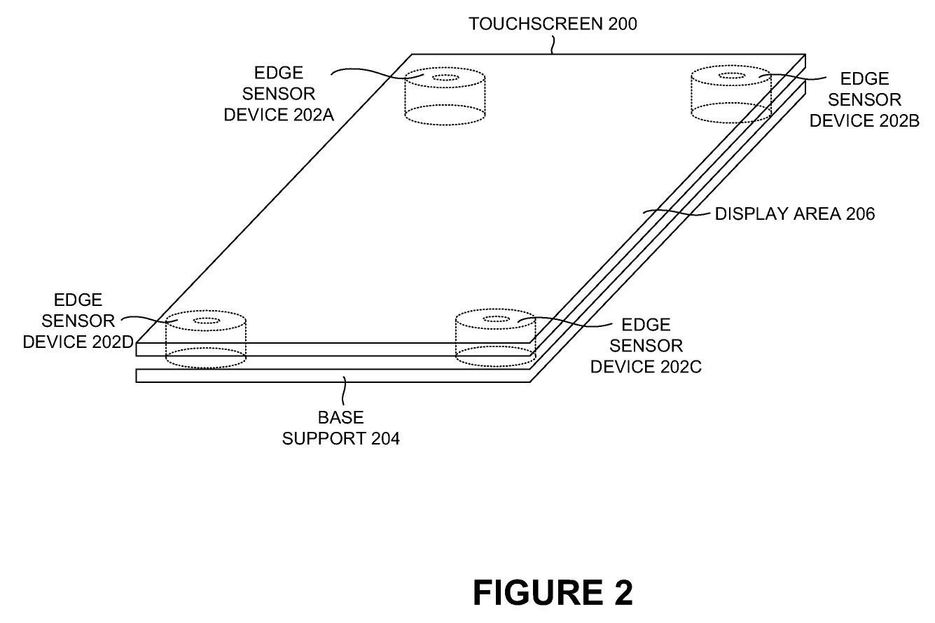

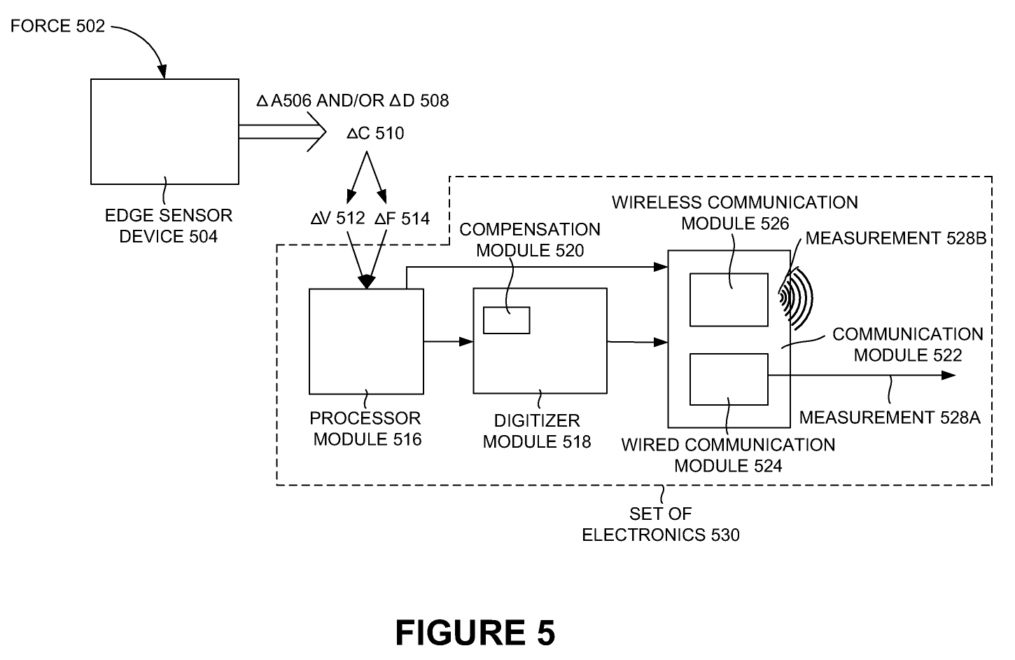

In one embodiment, a touchscreen (e.g., the touchscreen 200 of FIG. 2) includes a display area (e.g., the display area 206 of FIG. 2) of the touchscreen 200 (e.g., the area where one can communicate with the device), a set of edge sensors (e.g., the set of edge sensor devices 300A-N) at boundary locations of the display area 206 of the touchscreen 200, and a set of electronics (e.g., the set of electronics 530 of FIG. 5) to determine a location of a force and a magnitude of the force applied on the display area 206 of the touchscreen 200 using an algorithm (e.g., the center of force algorithm) that considers measurements the set of edge sensor devices 300A-N.

In another embodiment, a method includes capturing an observed measurement of a force from each of a set of edge sensors (e.g., set of edge sensor devices 300A-N of FIG. 2) near the force, and determining the location of the force and magnitude of the force applied on a display area (e.g., the display area 206 of FIG. 2) based on an algorithm (e.g., a center of force algorithm) that considers a reading of the force from each of the set of edge sensor devices 300A-N near the force.

A system includes a touchscreen surface, a base support surface, a set of edge sensors (e.g., set of edge sensor devices 300A-N of FIG. 2) between the touchscreen surface and the base support surface at corners of the surface to detect a force placed on the touchscreen 200, and a set of electronics (e.g., the set of electronics 530 of FIG. 5) associated with the set of edge sensor devices 300A-N to determine a location of a force and a magnitude of the force applied on the touchscreen surface using an algorithm that considers measurements the set of edge sensor devices 300A-N.

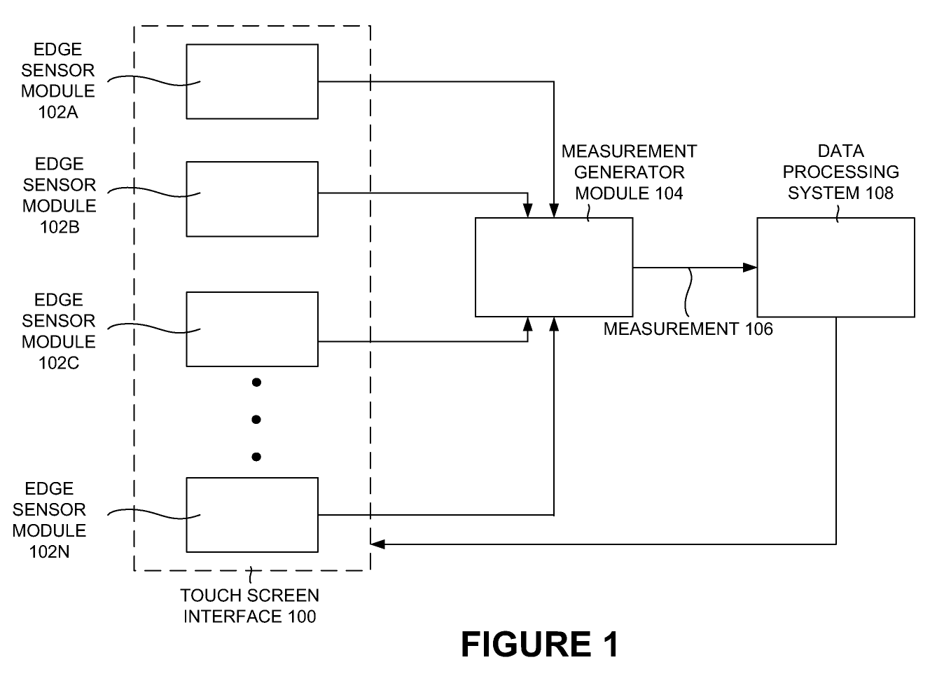

FIG. 1 is a system diagram of a touch screen interface 100 associated with a measurement generator module 104 and/or a data processing system 108, according to one embodiment. Particularly, FIG. 1 illustrates the touch screen interface 100, edge sensor modules 102A-N, a measurement generator module 104, a measurement 106, and a data processing system 108, according to one embodiment.

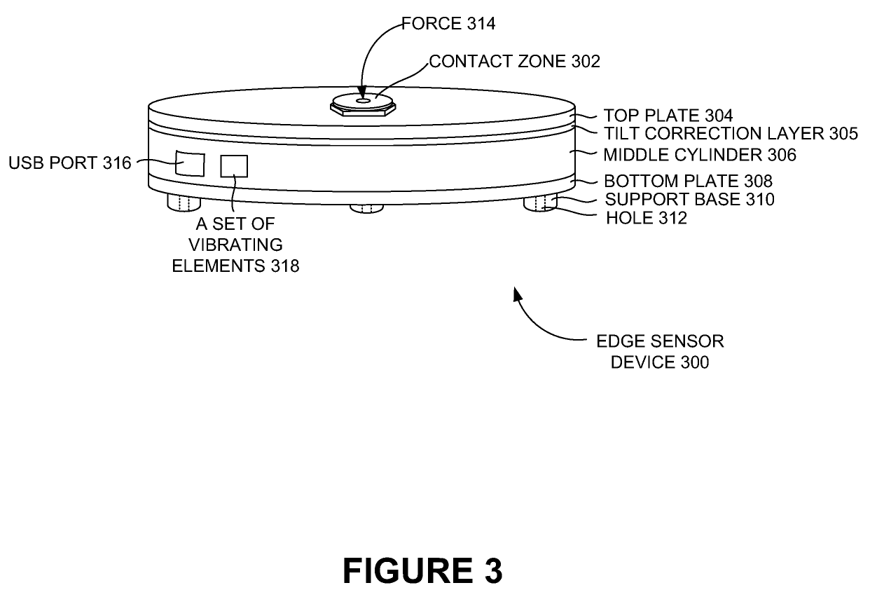

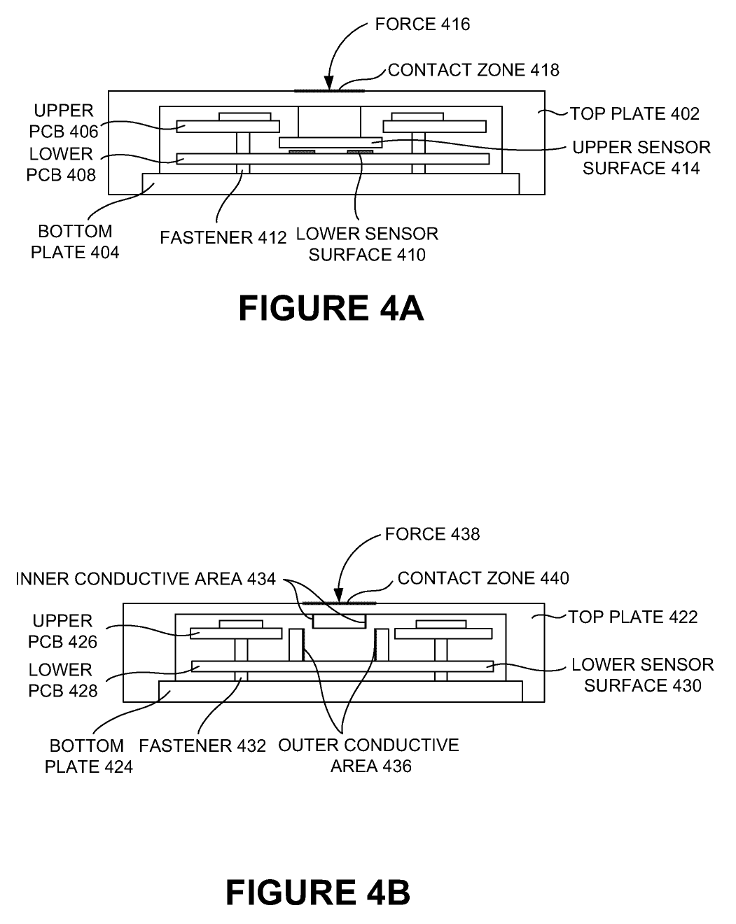

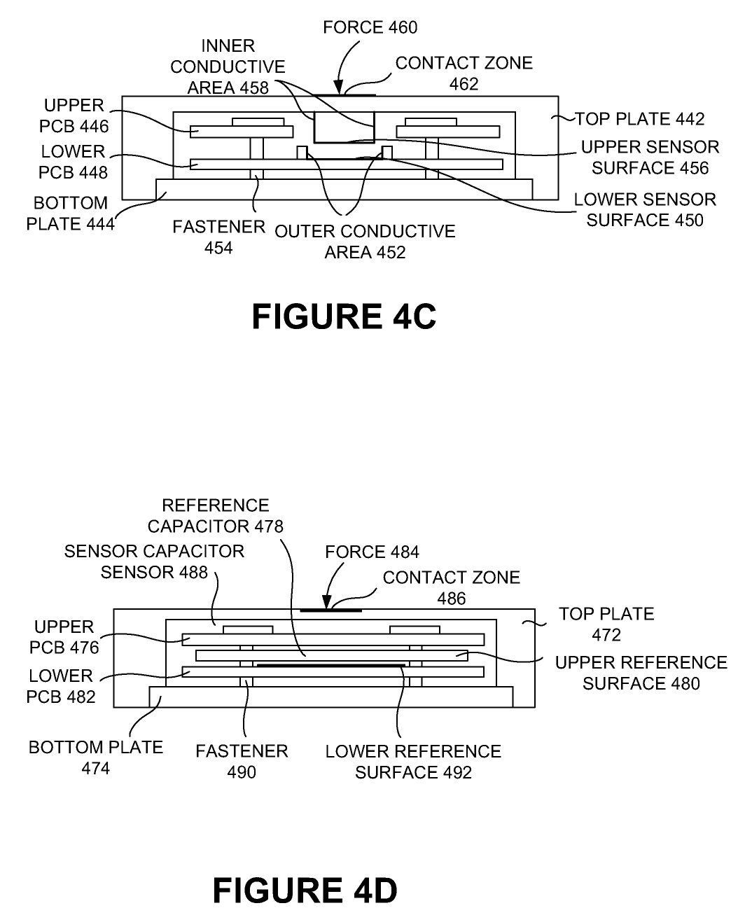

The touch screen interface 100 may be a display overlay which may have an ability to display and/or receive information on the same screen. The edge sensor modules 102A-N may be a sensor based on a capacitive sensing technique (e.g., may be an capacitive sensor with tilt compensation capability, etc.) as will be illustrated in FIG. 3 and/or FIG. 4. The measurement generator module 104 may take changes in data (e.g., change in voltage, change in capacitance, etc.) measured from the edge sensor modules 102A-N and/or may generate a measurement 106 (e.g., amount of force, etc.) based on information (e.g., change in area, displacement, etc.) taken from the edge sensor devices 202A-N. The measurement 106 may be information associated with the change in state of the edge sensor modules 102A-N which may be sent to the data processing system 108 for further process. The data processing system 108 (e.g., may be a computer, laptop, microcontroller driven device, etc.) may be a system which may process the information (e.g., may be a change in state of the edge sensor modules 102A-N) associated with the measurement 106.

In example embodiment, the touch screen interface 100 may comprise of the edge sensor modules 102A-N. The touch screen interface may receive a force (e.g., from a finger push on a screen, from a pointer, etc.). The measurement 106 may include force measurements taken at each of the edge sensor modules 102A-N. The forces may be summed to generate a total force measurement from the applied force (e.g., from a finger touching a screen, etc.). The data processing system 108 may calculate the position of the force applied to touch screen interface based on the measurement 106. Depending on the position at which the force may have been applied to the touch screen interface 100, the edge sensor modules 102A-N may have experienced a different applied force.

FIG. 2 is a three-dimensional view of edge sensor devices 202A-D placed between a touchscreen 200 and a base support 204, according to one embodiment. Particularly, FIG. 2 illustrates, touchscreen 200, edge sensor devices 202A-D, and a base support 204, according to on embodiment.

The touchscreen 200 may be an input/output device made of materials (e.g., glass, plastic etc.). The touchscreen 200 may display the information (e.g., which may be output), and may take input from a touch on the surface area of the touchscreen 200. The edge sensor devices 202A-D may be a set of sensors which may be placed under the touchscreen 200 and above the base support 204 to sense a force and a magnitude of force on the surface of the touchscreen 200. The base support 204 may be a support provided to the touchscreen 200 as well as to the edge sensor devices 202A-D.

In example embodiment, the edge sensor devices 202A-D may be placed under the touchscreen 200 such that when a force (e.g., a finger pressing the touch screen), a change in state (e.g., change in displacement, change in capacitance, etc.) in any of the edge sensor devices 202A-N may be measured. The edge sensor devices 202A-D may be placed above a base support (e.g., a glass plate, a plastic sheet, etc.).

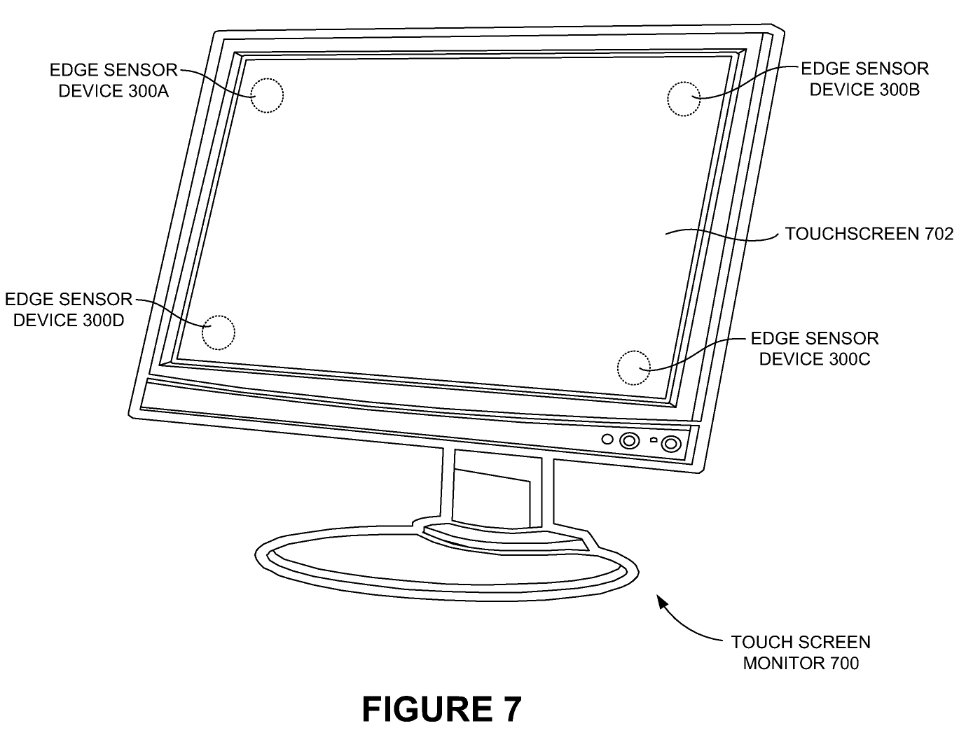

In one embodiment, a touchscreen (e.g., the touchscreen 200 of FIG. 2) may include a display area (e.g., display area 206 of FIG. 2) of the touchscreen 200 (e.g., as illustrated in FIG. 7). A set of edge sensors (e.g., the set of edge sensor devices 300A-N) may be placed at boundary locations of the display area 206 of the touchscreen 200 (e.g., as illustrated in FIG. 7). The display area 206 may be a rectangular shape, and/or there may be one edge sensor at each corner of the rectangular shape. The set of edge sensor devices 300A-N may be piezo-resistive sensors. The set of edge sensor devices 300A-N may be microelectromechanical sensors. The set of edge sensor devices 300A-N may be capacitive sensors. The touchscreen 200 may be removable from the display area 206 (e.g., such that the touchscreen can be placed on different display areas). The touchscreen 200 may include a set of vibrating elements (e.g., the set of vibrating elements 318 of FIG. 3) to provide a sensory feedback when the force may be applied on the display area 206.

The location of the force and the magnitude of the force may be measurable even when applied in an area slightly outside the display area 206. An observed measurement of the force may be captured (e.g., using the set of electronics 530 of FIG. 5) from each of a set of edge sensors (e.g., the set of edge sensor devices 300A-N) near the force. The location of the force and/or the magnitude of the force applied may be determined (e.g., using the set of electronics 530 of FIG. 5) on a display area (e.g., display area 206 of FIG. 2) based on an algorithm that considers a reading of the force from each of the set of edge sensor devices 300A-N near the force.

Individual force reading of each of the set of edge sensor devices 300A-N with a position on a plane of each of the set of edge sensor devices 300A-N may be multiplied to calculate a number (e.g., using the center of force algorithm). The number may be divided (e.g., using the center of force algorithm) by a sum of the individual force readings of all of the set of edge sensor devices 300A-N to determine the location of the force. The set of edge sensor devices 300A-N between the touchscreen 200 surface and/or the base support 204 surface at corners of the surface may detect a force placed on the touchscreen 200.

FIG. 3A is a three-dimensional view of an edge sensor device 300 having sensor capacitor (e.g., a sensor capacitor 488 in FIG. 4) and/or a reference capacitor (e.g., a reference capacitor 478 in FIG. 4), according to one embodiment. Particularly, FIG. 3 illustrates a contact zone 302, a top plate 304, a tilt correction layer 305, a middle cylinder 306, a bottom plate 308, a support base 310, a hole 312, a force 314, a USB port 316, and the set of vibrating elements 318, according to one embodiment.

The contact zone 302 may be a space where there may be a contact with the touchscreen 200. The tilt correction layer 305 may be a layer which may function as to correct any effects of tilt on the upper surface on the top plate 304. The middle cylinder 306, the bottom plate 308, the support base 310, and the hole 312 are all the parts of the which form the edge sensor device 300. The force 314 may be a force received from the touch screen. The USB port 316 may allow communication of information (e.g., change in state of the edge sensor device 300) with any of the processing devices. The set of vibrating elements 318 may provide a sensory feedback when the force 314 is applied on the display area 206.

In example embodiment, a force 314 (e.g., a load, a weight, a pressure, etc.) may be applied on top of the contact zone 302 deflecting the top plate 304. The top plate 302 deflected by the force 314 may move down an upper sensor printed circuit board (PCB) 406 of FIG. 4 of the sensor capacitor toward a lower PCB 408 producing a change in capacitance. In another example embodiment, a housing (e.g., which may include the top plate 304, the middle cylinder 306, and the bottom plate 308, or may include a different structure) may be made of a conductive and/or nonconductive material. In case the nonconductive material is being used, the nonconductive material may be painted (e.g., sputtered, coated, etc.) with the conductive material.

In one embodiment, the edge sensor device 300 may include a tilt correction layer (e.g., the tilt correction layer 305 of FIG. 3) to minimize an effect on a tilt on an upper surface of the edge sensor device 300.

FIGS. 4A, 4B, 4C, and 4D are cross-sectional views of the capacitive force measuring device, whereas FIGS. 4A, 4B, and 4C display three different ways of forming the sensor capacitor and FIG. 4D displays a formation of the reference capacitor, according to one embodiment.

In the FIG. 4A the edge sensor device 300 may include a top plate 402, a bottom plate 404, an upper PCB 406, a lower PCB 408, a lower sensor surface 410, a fastener 412, an upper sensor surface 414, and a contact zone 418. A sensor capacitor may be formed between the upper sensor surface 414 and the lower sensor surface 410. The upper PCB 406, the lower PCB 408 and the bottom plate 404 may be adjoined together using the fastener 412.

A deflection of the top plate 402 (e.g., due to the force 416) may cause a change in a distance between the upper sensor surface 414 and the lower sensor surface 410 of the sensor capacitor. The change in the distance may bring about a change in capacitance of the sensor capacitor. In one example embodiment, the upper sensor surface 414 and the lower sensor surface 410 are substantially parallel to each other and have the same physical area and/or thickness. The change in capacitance of the sensor capacitor may be inversely proportional to the change in the distance.

In the FIG. 4B, the edge sensor device 300 may include a top plate 422, a bottom plate 424, an upper PCB 426, a lower PCB 428, an outer conductive area 430, a fastener 432, an inner conductive area 434, and a contact zone 438. A sensor capacitor may be formed between the inner conductive area 434 and the outer conductive area 430. The upper PCB 426, the lower PCB 428 and the bottom plate 424 may be adjoined together using the fastener 432.

A deflection of the top plate 422 (e.g., due to the force 420) may cause a change in an overlap area of the inner conductive area 434 and the outer conductive area 430 of the sensor capacitor. The change in the overlap area may bring about a change in capacitance of the sensor capacitor. In one example embodiment, the inner conductive area 434 and the outer conductive area 430 may be substantially parallel to each other and have the same physical area and/or thickness. The change in capacitance of the sensor capacitor may be proportional to the change in the overlap area.

In the FIG. 4C, the edge sensor device 300 may include a top plate 442, a bottom plate 444, an upper PCB 446, a lower PCB 448, a lower sensor surface 450, an outer conductive area 452, a fastener 454, an upper sensor surface 456, an inner conductive area 458, and a contact zone 462. A sensor capacitor may be formed between the upper sensor surface 456 and the lower sensor surface 450 and/or between the inner conductive area 458 and the outer conductive area 452. The upper PCB 446, the lower PCB 448 and the bottom plate 444 may be adjoined together using the fastener 454.

A deflection of the top plate 442 (e.g., due to the force 460) may cause a change in a distance between the upper sensor surface 456 and the lower sensor surface 450 and/or a change in an overlap area of the inner conductive area 458 and the outer conductive area 452 of the sensor capacitor. The change in the distance and/or the overlap area may bring about a change in capacitance of the sensor capacitor. In one example embodiment, the upper sensor surface 456 and the lower sensor surface 450 (e.g., the inner conductive area 458 and the outer conductive area 452) are substantially parallel to each other and have the same physical area and/or thickness. The change in capacitance of the sensor capacitor may be inversely proportional to the change in the distance and/or proportional to the change in the overlap area.

In FIG. 4D, the edge sensor device 300 may include a top plate 472, a bottom plate 474, an upper PCB 476, a lower PCB 482, a lower reference surface 492, an upper reference surface 480, a fastener 490, and a contact zone 486. A reference capacitor 478 may be formed between the upper reference surface 480 and the lower reference surface 492. A sensor capacitor may be formed above the upper PCB 476. The upper PCB 476, the lower PCB 482 and the bottom plate 474 may be adjoined together using the fastener 484. The reference capacitor 478 may experience a change in capacitance only for environmental factors (e.g., humidity, a temperature, an air pressure, a radiation, etc.). Therefore, the environmental factors may be removed from a measurement of a change in capacitance of the sensor capacitor when the force 484 is applied to the capacitive force measuring device (e.g., thereby allowing a user to determine the change in capacitance of the sensor capacitor more accurately).

FIG. 5 is a process view of generating a measurement 528 based on a force 502 applied to the edge sensor device 300 of FIG. 3 and/or communicating the measurement 528 using a set of electronics 530, according to one embodiment.

In FIG. 5, a force 502 may be applied to the edge sensor device 300 when the top plate 402 of FIG. 4 is deflected by the force 502, according to one embodiment. An electronic circuitry (e.g., a software and/or hardware code) may apply an algorithm to measure a change in distance 508 between two plates (e.g., the upper sensor surface 414 and the lower sensor surface 410 in FIG. 4) of the sensor capacitor and/or a change in overlap area 506 between another two plates (e.g., the inner conductive area 434 and the outer conductive area 436 in FIG. 4) when the force 502 is applied to the edge sensor device 300.

Next, the change in capacitance 510 may be calculated based on the change in distance 508 between the two plates and the change in the overlap area 506 between the another two plates forming the sensor capacitor. The change in capacitance 510, a change in voltage 512, and/or a change in a frequency 514 may also be calculated to generate a measurement (e.g., an estimation of the force 502 applied to the capacitive sensor 504). Data which encompasses the change in capacitance 510, the change in voltage 512, and/or the change in frequency 514 may be provided to a processor module 516 which directly communicate to a communication module 522 (e.g., for analog data) and/or to a digitizer module 518 (e.g., for digital data). The digitizer module 818 may work with the processor module 516 (e.g., a microprocessor which may be integrated in a signaling circuit of the upper PCB 406 and/or the lower PCB 408 of FIG. 4) to convert the change in capacitance 510, the change in voltage 512, and/or the change in frequency 514 to a measurement 528.

The digitizer module 518 may also include a compensation module 520. The compensation module 520 may apply a measurement (e.g., digital) of one or more distortion factors to another measurement (e.g., digital) to minimize an effect of the one or more distortion factors to the edge sensor device 300 of FIG. 3. The communication module 522 includes a wired communication module 524 and/or a wireless communication module 526. The wired communication module 524 may communicate a universal serial bus (USB) signal, a voltage signal, a frequency signal, and/or a current signal in an analog and/or digital form to an external device. The wireless communication module 526 may wirelessly communicate with the external device based on one or more of wireless universal serial bus (USB), a Wi-Fi (e.g., of a wireless local area network), a Bluetooth (e.g., of a wireless personal area network), and/or a Zigbee (e.g., of the wireless sensor area network). The set of electronics may determine a location of a force (e.g., the force 502 of FIG. 5) and/or a magnitude of the force applied on the display area 206 of the touchscreen 200 using an algorithm (e.g., the center of force algorithm). The set of electronics may filter and/or compensate measurements of the set of edge sensor devices 300A-N to create more accurate readings using an error correction module.

In one example embodiment, the processor module 516 having a central procession unit (CPU) may execute a set of instructions associated with the digitizer module 518, the compensation module 520, and/or the communication module 522. In another example embodiment, a capacitance-to-frequency converter module may generate frequency data based on capacitance data of the capacitive sensor 504. The frequency data may be processed using a timer module coupled to the digitizer module 518. An effect of an input capacitance intrinsic to an operational amplifier coupled to the timer module may be minimized by driving a power supply of the operational amplifier such that a potential (e.g., voltage) of the input capacitance is substantially equivalent to a potential of a driving plate (e.g., the lower sensor surface 410 of FIG. 4) of the capacitive sensor 504. The set of electronics may include the processor module 516, the digitizer module 518, the compensation module 520, the communication module 522, the wired communication module 524, and the wireless communication module 526.

In one embodiment, the set of electronics 530 may determine a location of a force (e.g., the force 502 of FIG. 5) and/or a magnitude of the force applied on the display area 206 of the touchscreen 200 using an algorithm that may consider measurements the set of edge sensor devices 300A-N. The algorithm may be a center of force algorithm that may multiply individual force reading of each of the set of edge sensor devices 300A-N with a position on a plane of each of the set of edge sensor devices 300A-N to calculate a number, and divides the number by a sum of the individual force readings of all of the edge sensors. The set of electronics 530 may filter and/or compensate measurements of the set of edge sensors to create more accurate readings using an error correction module. The set of electronics 530 may be associated with the set of the set of edge sensor devices 300A-N to determine a location of a force and/or a magnitude of the force applied on the touchscreen 200 surface using an algorithm that considers measurements the set of edge sensors.

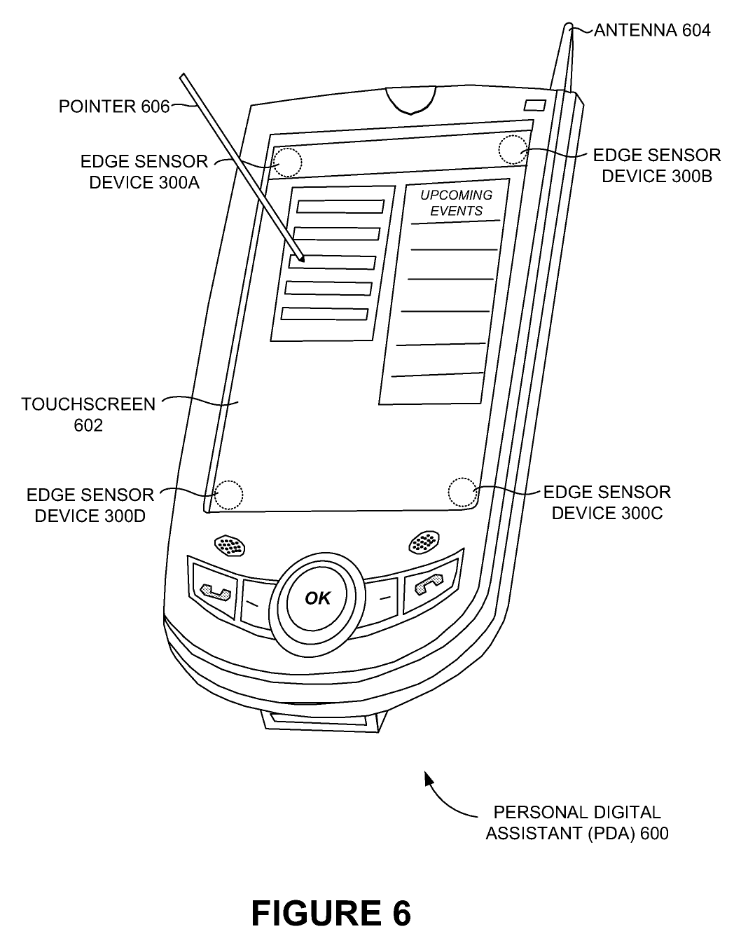

FIG. 6 is a three-dimensional view of a personal digital assistant (PDA) 600 having a touchscreen 602 based on the edge sensor device 300, according to one embodiment. Particularly, FIG. 6 illustrates the PDA 600, the touchscreen 602, the set of edge sensor devices 300A-D, an antenna 604 and a pointer 606, according to one embodiment.

A user may use the pointer 606 to input (e.g., may apply a bit of force) on the touchscreen 602, which may cause a localized force on the set of edge sensor devices 300A-D. The localized forces may be processed to determine the location of the applied force from the pointer 606. The antenna 604 may be used to transmit signals from the PDA 600. The pointer 606 may be a device which may be used to interact (e.g., select, navigate, etc.) with user interface on the touchscreen 602.

FIG. 7 is a three-dimensional view of a touchscreen monitor 700, according to one embodiment. Particularly, FIG. 7 illustrates the touchscreen monitor 700, having a touchscreen 702, and the set of edge sensor devices 300A-D according to one embodiment.

A user may touch a display on the touchscreen 702, applying a force (e.g., may vary from person to person). A measurement based on the force may be used to determine a position of the force and/or transmit this position as an input into a data processing system 108 (e.g., a computer, a PDA, etc).

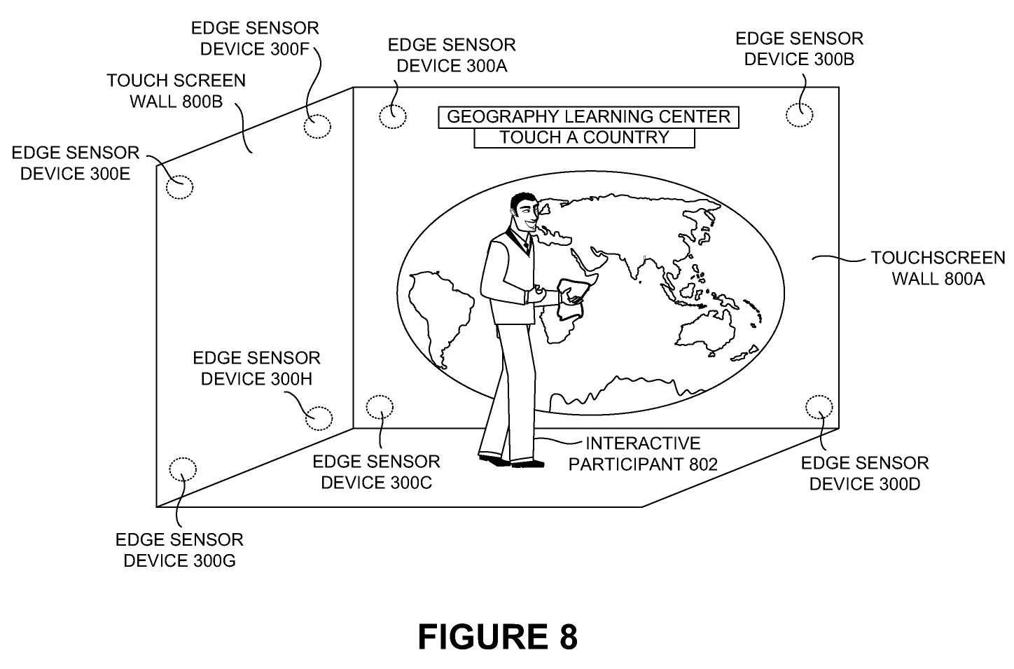

FIG. 8 is an illustrative view of touchscreen walls 800A-B, according to one embodiment. Particularly, FIG. 8 illustrates touchscreen walls 800A-B, an interactive participant 802, and the set of edge sensor devices 300A-N, according to one embodiment.

The touchscreen walls 800A-B may be a geography learning center, where the interactive participant 802 may touch the touchscreen walls 800A-B which may display an image of a map of the world. The force applied to the touchscreen walls 800A-B may be used as an input into a data processing system 108. The set of edge sensor devices 300A-N may be placed behind the touchscreen walls 800A-B.

In example embodiment, FIG. 8 illustrates a geography learning center which may have touchscreen walls 800A-B. The interactive participant 802 may use this touchscreen walls 800A-B for interacting with the data processing system 108 (e.g., computer, etc.). The touch (e.g., selection, choice, etc.) may be detected by the touchscreen walls 800A-B and force, magnitude of the force, and/or position of the touch may be detected by the set of edge sensor devices 300A-N placed at appropriate places as required.

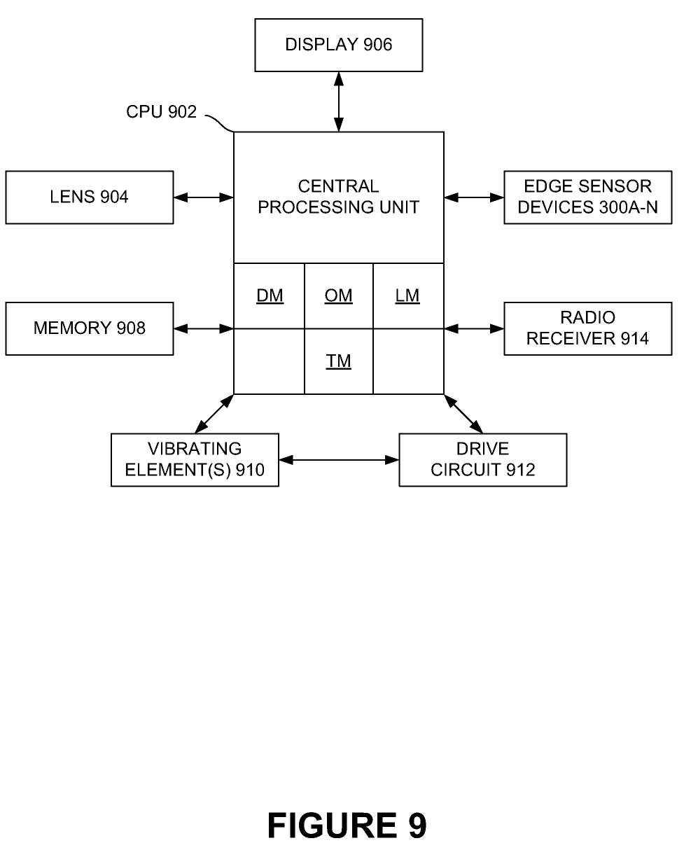

FIG. 9 is a system view of information processing from various input/output devices, according to one embodiment. Particularly, FIG. 9 illustrates the set of edge sensor devices 300A-N, a CPU (central processing unit) 902, lens 904, a display 906, memory 908, vibrating element(s) 910, and a drive circuit 912, according to one embodiment.

The CPU (central processing unit) 902 may be a processing unit which may process information coming from the input/output devices. The display 906 may be an input/output device (e.g., touchscreen). The memory 908 may be a data storage unit (e.g., hard disk, server, etc.). The vibrating element(s) 910 may provide a sensory feedback when the force is applied on the display area 206 (e.g., when touched, etc.). The drive circuit 912 may be used to drive the vibrating element(s) 910 and communicate with the the CPU 902.

In example embodiment, the CPU (central processing unit) may control all the input/output devices connected to it. Particularly it may take inputs from the set of edge sensor devices 300A-N, the radio receiver 914, the memory 908, the lens 904, the vibrating element(s) 910, and the drive circuit 912. The input data may be processed and/or output may be provided to output devices like the display 906.

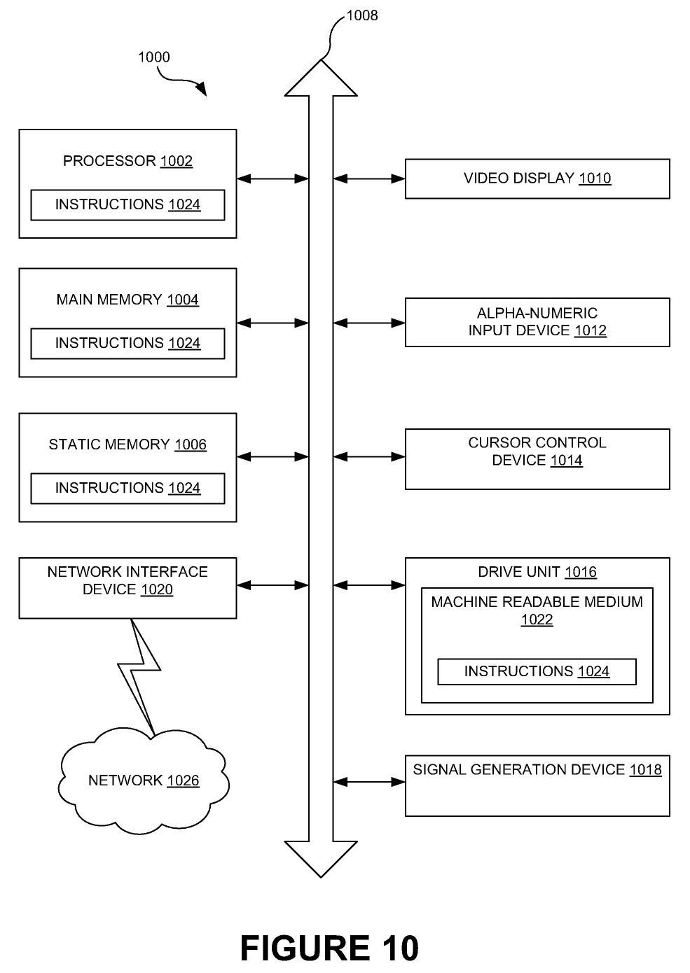

FIG. 10 is a diagrammatic system view 1000 of a data processing system in which any of the embodiments disclosed herein may be performed, according to one embodiment. Particularly, the diagrammatic system view 1000 of FIG. 10 illustrates a processor 1002, a main memory 1004, a static memory 1006, a bus 1008, a video display 1010, an alpha-numeric input device 1012, a cursor control device 1014, a drive unit 1016, a signal generation device 1018, a network interface device 1020, a machine readable medium 1022, instructions 1024 and a network 1026, according to one embodiment.

The diagrammatic system view 1000 may indicate a personal computer and/or a data processing system in which one or more operations disclosed herein may be performed. The processor 1002 may be a microprocessor, a state machine, an application-specific integrated circuit, a field programmable gate array, etc. (e.g., Intel® Pentium® processor). The main memory 1004 may be a dynamic random access memory and/or a primary memory of a computer system. The static memory 1006 may be a hard drive, a flash drive, and/or other memory information associated with the data processing system.

The bus 1008 may be an interconnection between various circuits and/or structures of the data processing system. The video display 1010 may provide graphical representation of information on the data processing system. The alpha-numeric input device 1012 may be a keypad, a keyboard and/or any other input device of text (e.g., a special device to aid the physically challenged). The cursor control device 1014 may be a pointing device such as a mouse.

The drive unit 1016 may be the hard drive, a storage system, and/or other longer term storage subsystem. The signal generation device 1018 may be a bios and/or a functional operating system of the data processing system. The network interface device 1020 may be a device that may perform interface functions such as code conversion, protocol conversion and/or buffering required for communication to and from a network.

The machine readable medium 1022 may provide instructions on which any of the methods disclosed herein may be performed. The instructions 1024 may provide source code and/or data code to the processor 1002 to enable any one or more operations disclosed herein.

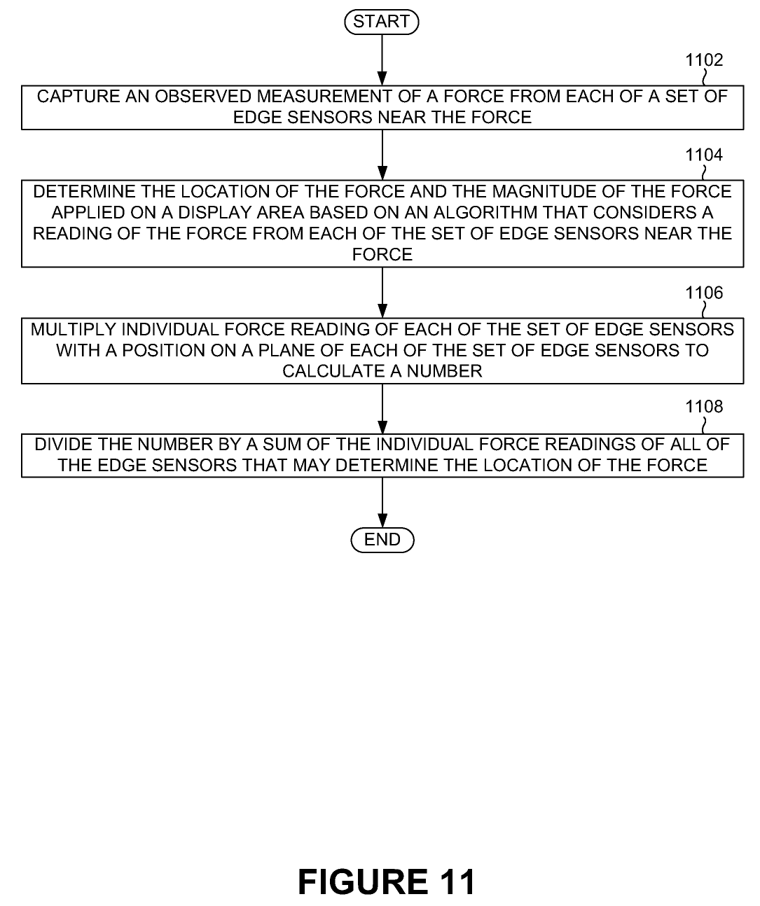

FIG. 11 is a process flow of capturing a measurement of force from a set of edge sensors (e.g., the set of edge sensor devices 300A-N), according to one embodiment. In operation 1102, an observed measurement of a force may be captured (e.g., using the set of electronics 530 of FIG. 5) from each of a set of edge sensors (e.g., the set of edge sensor devices 300A-N) near the force. In operation 1104, the location of the force and/or the magnitude of the force applied may be determined (e.g., using the set of electronics 530 of FIG. 5) on a display area (e.g., display area 206 of FIG. 2) based on an algorithm that considers a reading of the force from each of the set of edge sensor devices 300A-N near the force.

In operation 1106, individual force reading of each of the set of edge sensor devices 300A-N with a position on a plane of each of the set of edge sensor devices 300A-N may be multiplied to calculate a number (e.g., using the center of force algorithm). In operation 1108, the number may be divided (e.g., using the center of force algorithm) by a sum of the individual force readings of all of the set of edge sensor devices 300A-N to determine the location of the force.

The display area 206 may be a rectangular shape, and there may be one edge sensor at each corner of the rectangular shape. The set of edge sensors may be piezo-resistive sensors. The set of edge sensor devices 300A-N may be microelectromechanical sensors. The set of edge sensor devices 300A-N may be capacitive sensors.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated (ASIC) Circuitry and/or in Digital Signal Processor (DSP) circuitry).

Particularly, the edge sensor modules 102A-N, the measurement generator module 104, the processor module 516, the digitizer module 518, the compensation module 520, the communication module 522, the wired communication module 524, the wireless communication module 526, and the other modules may be enabled using software and/or using transistors, logic gates, and electrical circuits (e.g., application specific integrated ASIC circuitry) such as edge sensor circuits, a measurement generator, a processor circuit, a digitizer circuit, a compensation circuit, a communication circuit, a wired communication circuit, a wireless communication circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A touchscreen, comprising:
a display area of the touchscreen;
a set of edge sensors at boundary locations of the display area of the touchscreen; and
a set of electronics to determine a location of a force and a magnitude of the force applied on the display area of the touchscreen using an algorithm that considers measurements the set of edge sensors.

2. The touchscreen of claim 1 wherein the algorithm is a center of force algorithm that multiplies individual force reading of each of the set of edge sensors with a position on a plane of each of the set of edge sensors to calculate a number, and divides the number by a sum of the individual force readings of all of the edge sensors.

3. The touchscreen of claim 1 wherein the display area is a rectangular shape, and there is one edge sensor at each corner of the rectangular shape.

4. The touchscreen of claim 3 wherein the set of edge sensors are piezo-resistive sensors.

5. The touchscreen of claim 3 wherein the set of edge sensors are microelectromechanical sensors.

6. The touchscreen of claim 3 wherein the set of edge sensors are capacitive sensors.

7. The touchscreen of claim 6 wherein the capacitive sensors to include a tilt correction layer to minimize an effect on a tilt on an upper surface of the capacitive sensor.

8. The touchscreen of claim 1 wherein the set of electronics to filter and to compensate measurements of the set of edge sensors to create more accurate readings using an error correction module.

9. The touchscreen of claim 1 wherein the touchscreen is removable from the display area, such that the touchscreen can be placed on different display areas.

10. The touchscreen of claim 1 wherein the touchscreen to include a set of vibrating elements to provide a sensory feedback when the force is applied on the display area.

11. The touchscreen of claim 1 wherein the location of the force and the magnitude of the force is measurable even when applied in an area slightly outside the display area.

12. A method comprising:
capturing an observed measurement of a force from each of a set of edge sensors near the force; and
determining a location of a force and a magnitude of the force applied on a display area based on an algorithm that considers a reading of the force from each of the set of edge sensors near the force.

13. The method of claim 12 further comprising
multiplying individual force reading of each of the set of edge sensors with a position on a plane of each of the set of edge sensors to calculate a number; and
dividing the number by a sum of the individual force readings of all of the edge sensors to determine the location of the force.

14. The method of claim 13 wherein the display area is a rectangular shape, and there is one edge sensor at each corner of the rectangular shape.

15. The method of claim 12 wherein the set of edge sensors are piezo-resistive sensors.

16. The method of claim 12 wherein the set of edge sensors are microelectromechanical sensors.

17. The method of claim 12 wherein the set of edge sensors are capacitive sensors.

18. A system, comprising:
a touchscreen surface;
a base support surface;
a set of edge sensors between the touchscreen surface and the base support surface at corners of the surface to detect a force placed on the touchscreen; and
a set of electronics associated with the set of edge sensors to determine a location of a force and a magnitude of the force applied on the touchscreen surface using an algorithm that considers measurements the set of edge sensors.

19. The system of claim 18 wherein the algorithm is a center of force algorithm that multiplies individual force reading of each of the set of edge sensors with a position on a plane of each of the set of edge sensors to calculate a number, and divides the number by a sum of the individual force readings of all of the edge sensors.

20. The system of claim 19 wherein the set of electronics to filter and compensate measurements of the set of edge sensors to create more accurate readings using an error correction module.
